(19) United States
(12) Patent Application Publication
(10) Pub. No.: US 2026/0171304 A1
(43) Pub. Date: Jun. 18, 2026

(54) MODULAR POWER TRANSFORMERS AND METHODS OF INSTALLING THE SAME

(71) Applicant: One Power Company, Findlay, OH (US)

(72) Inventors: Jereme Kent, Findlay, OH (US); Erica Johnson, Findlay, OH (US); Chelsea Bumb, Findlay, OH (US); Logan Tebbe, Findlay, OH (US); Brian Curkendall, Findlay, OH (US)

(73) Assignee: One Power Company, Findlay, OH (US)

(21) Appl. No.: 19/421,671

(22) Filed: Dec. 16, 2025

Related U.S. Application Data
(60) Provisional application No. 63/734,322, filed on Dec. 16, 2024.

(51) Int. Cl. H01F 27/40; H01F 27/02; H01F 41/00

(52) U.S. Cl. CPC H01F 27/402; H01F 27/02; H01F 41/00

(57) ABSTRACT

A modular power transformer is disclosed, comprising a housing with a plurality of sidewalls, a tank base, and a top plate. The transformer includes a containment tray positioned beneath the housing, configured to fit within the footprint of a plurality of drive legs but outside the footprint of the housing. The containment tray consists of three pieces that can be attached to each other once the drive legs are removed, creating fluid communication between the pieces. The containment tray features gravity drain filters that automatically close upon detecting leaks, preventing environmental contamination.

### FIELD

This disclosure relates to power transformers and methods of installing the same.

### BACKGROUND

Power transformers play a critical role in the transmission and distribution of electrical energy across power grids. These transformers are responsible for stepping up or stepping down voltage levels to facilitate efficient long-distance transmission and distribution to end users. Modern transformers must operate efficiently under varying load conditions, often in demanding environments, and with the ability to be monitored remotely to ensure optimal performance and safety.

Traditional transformers face several challenges, including vulnerability to environmental and operational hazards, complex installation procedures, and limited monitoring capabilities. Many transformers require specialized equipment for transportation, suffer from inadequate security measures, and lack real-time monitoring systems for condition-based maintenance.

A need exists, therefore, for improved modular power transformers and methods of installing the same

### BRIEF SUMMARY OF SELECTED EXAMPLES

This disclosure addresses these challenges by presenting a transformer with a modular design. The transformer is configured to facilitate ease of installation, enhanced safety, and continuous remote monitoring to detect potential faults before they become critical. Additionally, the transformer's design includes reinforced structural components, redundant communication systems, and mobility features for simplified transportation and positioning.

One embodiment is a transformer. The transformer includes a housing and a containment tray. The housing includes a plurality of sidewalls, a tank base, and a top plate. The containment tray is disposed below the housing. The containment tray is configured to fit within the footprint of a plurality of drive legs. The containment tray is further configured to fit outside the footprint of the housing. The containment tray is defined by three pieces. The pieces of the containment tray are in fluid communication when attached to each other. The containment tray includes gravity drain filters that automatically closes upon leak detection.

An example transformer comprises a housing including a plurality of sidewalls, a tank base, and a top plate; an input and an output attached to the top plate and in electrical communication with a grid; a plurality of attachment arms extractable from the housing, each of the plurality of attachment arms having a drive leg mounting plate; a support arm removably attached to each of the drive leg mounting plates, each of the support arms being relatively perpendicular to each of the plurality of attachment arms; a wheel attached to each of the support arm; and a containment tray having a plurality of sidewalls disposed below the tank base.

Another example transformer comprises a housing including a plurality of sidewalls, a tank base, and a top plate; an input and an output attached to the top plate and in electrical communication with a grid; a plurality of attachment arms extractable from the housing, each of the plurality of attachment arms having a drive leg mounting plate, the plurality of attachment arms includes two attachment arms on a first side and two attachment arms on a second side that is opposite of the first side; a support arm removably attached to each of the drive leg mounting plates, each of the support arms being relatively perpendicular to each of the plurality of attachment arms; a wheel attached to each of the support arms; and a containment tray having a plurality of sidewalls disposed below the tank base, the containment tray including a first portion, a second portion, and a third portion attachable to each other upon removal of the support arms.

An example method of installing a transformer comprises placing a first portion of a containment tray in a position where said transformer is to be installed; extracting a plurality of attachment arms from said transformer, each support arm having a drive leg mounting plate, said transformer comprising a housing having a plurality of sidewalls, a tank base, a top plate, an input, and an output; attaching a support arm having a wheel attached to each of the drive leg mounting plates; rolling said transformer such that the first portion of the containment tray is disposed below the tank base; placing the tank base on the first portion of the containment tray; removing the support arms from each of the drive leg mounting plates; retracting the plurality of attachment arms into said transformer; and connecting the input and the output to an electrical grid.

### BRIEF DESCRIPTION OF FIGURES

FIG. 1 is an illustration of an example modular transformer.

FIG. 2 is an illustration of the modular transformer of FIG. 1 disposed on a transformer trailer.

FIG. 3 is an illustration of the modular transformer of FIG. 1 disposed on a containment tray.

FIG. 4 illustrates a diagram of a method of installing a transformer.

### DETAILED DESCRIPTION OF SELECTED EXAMPLES

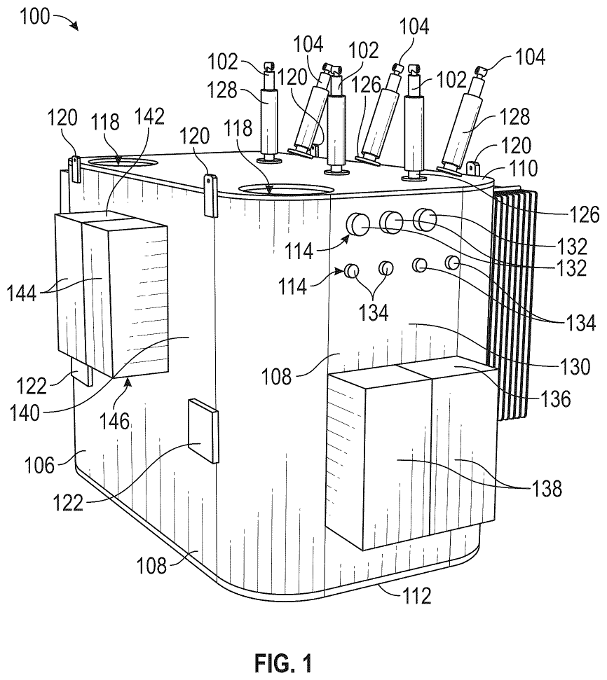

Each of FIGS. 1, 2, and 3 illustrates an example transformer system. FIG. 1 illustrates an example transformer 100. The transformer 100 contains a core, not illustrated. The core may be composed of laminated steel, or any other suitable material. Laminated steel acts to reduce energy losses from eddy currents within the core. The core conducts a magnetic field between a plurality of primary and secondary windings. The windings, not illustrated, may be made of copper, aluminum, or any other suitable material. The windings are arranged around the core to allow for efficient transfer of electrical energy from an input 102 to an output 104.

The transformer 100 is cooled using a cooling fluid. The cooling fluid may consist of oil, ester-based insulating fluid, or any other suitable substance. The fluid circulates within the transformer 100 to dissipate the heat generated during operation. The cooling fluid may limit the temperature of the transformer 100 to operating temperature, such that the transformer 100 functions reliably under various load conditions. The transformer 100 may include the use of ester oil, which is both fire-resistant and over 99% biodegradable as the cooling fluid.

The transformer 100 includes features to facilitate security, reliability, and ease of use. The transformer 100 may include redundant SEL TiDL merging units and an SEL RPM. These units may provide continuous communication and monitoring even after a power fault. Remote monitoring capabilities via 5G, or by any other suitable means, allow for continuous oversight of the transformer 100. The communications from the transformer 100 may be encrypted to prevent unauthorized individuals from obtaining information from the transformer 100.

The transformer 100 includes a condition monitoring system, not illustrated. The condition monitoring system includes advanced sensors for dissolved gas analysis (DGA), temperature monitoring, and oil level monitoring. These sensors feed data into a centralized programmable logic controller (PLC), not illustrated. The PLC may allow for remote access to the transformer's condition and performance by internet, Bluetooth, or any other suitable means. The transformer 100 also includes safety features, such as, but not limited to, automatic closing valves that prevent core damage in the event of a low oil level.

A housing 106 encloses the internal components, not illustrated, of the transformer 100. The housing 106 provides structural support and protection from external environmental factors and potential threats such as, but not limited to, precipitation and animals. The housing 106 is defined by a plurality of sidewalls 108, a top plate 110, and a tank base 112.

The plurality of sidewalls 108 are attached to each other along their vertical edges. The sidewalls 108 are disposed and attached such that they form a rectangular prism, enclosing the internal components of the transformer 100. The sidewalls 108 connect to the tank base 112 at the bottom and to the top plate 110 at the top, creating a relatively sealed enclosure. The sidewalls 108 are configured to receive the tank base 112 and the top plate 110 such as to form a rectangular prism. Either of the tank base 112 and the top plate 110 may be attached to the sidewalls 108 through various attachment methods including welded connections, bolted connections, or any other suitable means.

In the presented embodiment, the plurality of sidewalls 108 have a rolled shell construction. This construction method involves rolling steel plates into a curved shape before assembly. This process enhances the structural strength of the housing 106. This process further reduces stress concentrations on the housing 106. In this embodiment, the plurality of sidewalls 108 have a wall thickness of approximately 1.5 inches. Sidewalls of this this thickness provides increased resistance to mechanical impacts and environmental hazards. However, the wall thickness can be any suitable thickness including, but not limited to, 1 inch, 2 inches, 3 inches, and 4 inches.

The plurality of sidewalls 108 of this embodiment are bullet-resistant. An example of a caliber of round the plurality of sidewalls 108 are able to resist are .308 caliber rounds, meeting the UL 752-Level 8 standard. This bullet resistance enhances the security of the transformer 100 by protecting the internal components from ballistic threats. The plurality of sidewalls 108 are pressure-rated to exceed 100 PSI. This pressure rating allows the housing 106 to withstand internal pressures caused by thermal expansion of the insulating fluids or sudden pressure surges without deformation or rupture.

In the presented embodiment, the plurality of sidewalls 108 only includes two weld seams. The limited number of weld seams reduces potential points of weakness or leak paths in the structure. All shell holes 114 in the sidewalls 108 are plasma cut prior to rolling. Plasma cutting provides precise and clean cuts. However, the shell holes 114 can be formed by any suitable means.

The tank base 112 is located at the bottom of the housing 106 and connects to the sidewalls 108 along their lower edges. The tank base 112 is configured to be attached to the plurality of sidewalls 108 through welded connections, or any other suitable means. This creates a practically leak-proof joint. However, the tank base 112 can be attached to the sidewalls 108 by any suitable means. The tank base 112 of the presented embodiment is at least 2 inches thick. The presented thickness allows tank base 112 to support the weight of a fully loaded transformer 100, including the core, the windings, and the insulating fluid.

The tank base 112 can support the weight of fully loaded transformer 100 on any of its corners. This allows the transformer 100 to be supported or lifted from various points without compromising structural integrity. The tank base 112 is configured to lie flat on the ground or a containment tray 116, distributing the weight evenly and providing a stable foundation. The tank base 112 does not require any additional reinforcement.

The top plate 110 is positioned atop the plurality of sidewalls 108 and completes the housing 106 at the top. The top plate 110 connects to the sidewalls 108 along their upper edges, completing the relatively sealed enclosure. The top plate 110 is configured to attach to the plurality of sidewalls 108 through welded or bolted connections. However, the plurality of sidewalls 108 can be attached to the top plate 110 by any suitable means. The top plate 110 is configured to withstand high levels of explosives from drone attacks or any other type of attack on the transformer 100. This resistance enhances the security of transformer 100 against potential aerial threats, protecting the transformer's 100 infrastructure.

The top plate 110 of the present embodiment is at least 1.5 inches thick. This thickness contributes to its ability to resist mechanical impacts, blast forces, and penetration. The top plate 110 defines an aperture 118. The aperture 118 may serve as a tank access, allowing personnel to access the interior of the transformer 100 for maintenance, inspection, or repair. The aperture 118 is located on the top plate 110 and may be positioned centrally or at specific locations to facilitate access to the internal components of the transformer 100.

In some embodiments, the top plate 110 may include a plurality of apertures 118. Multiple apertures 118 may provide easier access to different internal areas, such as the core, the windings, or the cooling systems. The aperture 118 may be sealed with removable covers or hatches when not in use, preventing environmental contaminants, moisture, or debris from entering housing 106. Seals or gaskets may be used, in conjunction with the removable covers or hatches or alone, to ensure a watertight and airtight closure.

In addition to structural protection, the housing 106 serves as a mounting point for other components. For example, in some embodiments, a plurality of lifting lugs 120 may be attached to the housing 106. This plurality of lifting lugs 120 allows the transformer 100 to be lifted and transported using cranes or other lifting equipment. The housing 106 may further include attachment points, not illustrated, for a plurality of drive leg mounting plates 122, facilitating the installation of a plurality of drive legs 124 for mobility or positioning the transformer 100.

In the illustrated embodiment, there are three inputs 102 and three outputs 104; however, any suitable number of inputs 102 and outputs 104 may be present. The inputs 102 and the outputs 104 are disposed on and attached to the top plate 110 of the transformer 100. The inputs 102 connect to the primary winding inside the transformer 100. The outputs 104 connect to the secondary winding. The placement of the inputs 102 and the outputs 104 on the top plate 110 allows for convenient connection to overhead transmission lines and facilitates easy access for installation and maintenance. Each of the inputs 102 and the outputs 104 are in electrical communication with a power grid.

The configuration of the power grid, not illustrated, may determine the configuration of the transformer 100. If the power grid supplies high voltage at the input 102, the transformer 100 may be used in step-down mode to reduce the voltage to a lower level suitable for distribution networks or end-user applications. In this mode, the transformer 100 lowers the voltage from a higher primary voltage to a lower secondary voltage.

If the power grid supplies low voltage at the input 102, the transformer 100 may be used in step-up mode to increase the voltage for efficient long-distance transmission. By raising the voltage level, the transformer 100 reduces current flow for the same power level, minimizing resistive losses in transmission lines.

A plurality of bushings 126 are used for the inputs 102 and the outputs 104. The bushings 126 are mounted on the top plate 110 and around each of the inputs 102 and the outputs 104 and provide insulated passages for electrical conductors, such as the inputs 102 and the outputs 104, to enter and exit the housing 106 without electrical contact with a grounded structure. The bushings 126 prevent electrical contact between the conductors 102, 104 and the housing 106, ensuring safe operation and preventing short circuits. The bushings 126 may be made of high-quality porcelain or composite materials that can withstand high electrical stress, thermal variations, and environmental conditions such as moisture and pollution.

A plurality of surge arrestors 128 are disposed around the inputs 102 and the outputs 104 on the top plate 110. The surge arrestors 128 are connected between the high-voltage conductors and ground. The surge arrestors 128 protect the transformer 100 from transient overvoltages such as lightning strikes, switching surges, or other voltage spikes that can occur on the power grid. The surge arrestors 128 provide a low-impedance path for excessive surge currents to be safely diverted to ground, thus preventing insulation breakdown, equipment damage, and ensuring the continuity of service. The surge arrestors 128 may be constructed using metal oxide varistor, or any other suitable materials.

In the presented embodiment, the transformer 100 has key ratings suitable for various power grid applications. The transformer 100 has a power rating of 30 MVA, capable of operating in both step-up and step-down modes at all tap positions. However, in alternative embodiments, the transformer 100 has power ratings ranging between but not limited to, 20 MVA and 50 MVA. The primary voltage rating is 138 kV, with coarse taps available for 115 kV configurations. The secondary voltage rating is 34.5 kV, suitable for medium voltage distribution networks. However, in alternative embodiments, the primary voltage rating can range between, but is not limited to, 100 kV and 160 kV, and the secondary voltage rating can range between, but is not limited to, 20 kV and 50 kV.

The transformer 100 includes fine taps at −10%, −5%, −2.5%, 0%, +2.5%, and +5%. These fine taps are de-energized tap changers (DETC). The fine taps allow voltage adjustments when the transformer 100 is not under load. The −10% tap position may accommodate 415 VAC phase-to-phase nominal systems using 480 VAC transformers. Coarse taps at 138 kV and 115 kV enable transformer 100 to interface with the power grids operating at these high-voltage levels. In some embodiments, the transformer 100 may have a delta (Δ) primary winding and a wye-grounded (Yn) secondary winding configuration, known as DYn.

A nitrogen blanket, not illustrated, is used within the housing 106 of the transformer 100. The nitrogen blanket fills the space above the insulating oil, providing an inert atmosphere that prevents oxidation and moisture ingress. By displacing oxygen, the nitrogen blanket inhibits the formation of combustible gases and prolongs the life of the insulating oil and the internal components.

Embedded fiber optics, not illustrated, in the windings measure winding temperatures directly, providing accurate real-time thermal data. This allows for precise monitoring of load conditions and early detection of overheating, which could lead to insulation degradation or failures. The embedded fiber optics in the core measure core temperatures, detecting hotspots that could indicate issues such as core lamination shorts or localized losses. Top, bottom, and midpoint oil temperatures are monitored to assess the effectiveness of the cooling system. An oil level sensor monitors the insulating oil level within transformer 100 to detect leaks or insufficient oil volume, which could compromise insulation and cooling performance.

In the presented embodiment, the condition monitoring system performs a nine-gas dissolved gas analysis (DGA) every 10 minutes. The DGA detects concentrations of gases such as hydrogen, methane, ethane, ethylene, acetylene, carbon monoxide, carbon dioxide, oxygen, and nitrogen. These gases are byproducts of decomposition of the insulating materials under thermal and electrical stress. By analyzing the gas concentrations and their ratios, the system can identify potential faults like arcing, overheating, or partial discharges, enabling early intervention before catastrophic failures occur.

A control section 130 is defined by one of the plurality of sidewalls 108. The control section 130 includes a plurality of indicator status lights 132, a plurality of indicator meters 134, and a control cabinet 136. The indicator status lights 132 are situated above control cabinet 136. The indicator status lights 132 provide immediate visual indications of the transformer operational status. The indicator status lights 132 may display alerts for conditions such as, but not limited to, overtemperature, low oil level, overcurrent, gas accumulation, or system faults. The indicator status lights 132 allow operators and maintenance personnel to quickly assess the status of the transformer 100 from a distance.

The indicator status lights 132 may utilize LED technology for reliability and energy efficiency. The indicator status lights 132 may be color-coded and labeled to represent specific conditions. For example, a green light may indicate normal operation, yellow may indicate a warning, and red may signal an alarm or critical fault. Additionally, flashing patterns may be used to differentiate between types of alerts.

The indicator meters 134 are also located above the control cabinet 136. The indicator meters 134 display real-time measurements of parameters such as primary and secondary voltages, load currents, oil and winding temperatures, oil pressure, and frequency. The indicator meters 134 may assist operators in monitoring the performance of transformer 100.

The indicator meters 134 may be digital displays with high visibility, even in bright sunlight or low-light conditions. They may include backlighting, anti-glare screens, and may be designed to withstand temperature variations and mechanical shocks. The indicator meters 134 may also feature multifunctional displays, allowing operators to switch between different parameters as needed.

The control cabinet 136 houses the control and monitoring equipment, not illustrated, of the transformer 100. The control cabinet 136 is mounted on the housing 106. The control cabinet 136 protects sensitive electronic components from external environmental factors such as moisture, dust, and temperature extremes, as well as from unauthorized access. Control cabinet doors 138 provide access to the interior of the control cabinet 136 for authorized personnel during maintenance and inspection. The control cabinet doors 138 may be equipped with locks and seals to prevent access to the control cabinet 136 by individuals, animals, and the external environment.

The control section 130 includes a programmable logic controller (PLC), not illustrated, located inside the control cabinet 136. The PLC is a central processing unit for control and monitoring functions of the transformer 100. The PLC receives inputs from various sensors and devices, not illustrated, within transformer 100, including the condition monitoring system. The inputs to the PLC may include data from embedded fiber optic temperature sensors in the windings, the core, the oil level sensors, the pressure sensors, the dissolved gas analysis (DGA) equipment, and any other suitable sensors or equipment.

The PLC processes this data in real-time, allowing for automated control actions and alerts. For example, if the PLC detects an overtemperature condition, it may initiate cooling system operations or trigger alarms. The PLC may also control auxiliary systems such as fans, pumps, tap changers, and protective relays.

The control cabinet 136 may contain communication interfaces that enable remote monitoring and control of the transformer 100. These interfaces may include fiber optic communication ports, ethernet connections, wireless communication modules, or any other suitable means of communication. The control cabinet 136 may further include protective relays, not illustrated. The protective relays are devices configured to detect electrical faults such as overcurrent, differential current, or ground faults. The protective relays may initiate protective actions like circuit breaker tripping to safeguard the transformer 100. The control cabinet 136 may further include power supplies, not illustrated. The power supplies are units that provide regulated voltages to electronic components. The power supplies may include backup options such as uninterruptible power supplies to ensure continuous operation during power disturbances. The control cabinet 136 may house a human machine interface (HMI), not illustrated. The HMI provides interactive displays that allow operators to view detailed information, adjust settings, and perform diagnostic tests. The control cabinet 136 may house breakers and fuses, not illustrated. The breakers and fuses may provide overcurrent protection for the internal circuits within the control cabinet 136.

A medium voltage section 140 is mounted on the housing 106. The medium voltage section 140 includes a medium voltage cabinet 142 and medium voltage cabinet doors 144. The medium voltage cabinet 142 houses medium voltage connections and protective devices, not illustrated, of the transformer 100. The medium voltage cabinet doors 144 provide access to the interior of the medium voltage cabinet 142 for installation, operation, and maintenance purposes. The medium voltage cabinet doors 142 may be equipped with locks and seals to prevent unauthorized access and protect against environmental factors such as moisture, dust, and temperature extremes.

Inside the medium voltage cabinet 142, 600 A deadbreak elbows, not illustrated, are installed, one per phase. The 600 A deadbreak elbows provide connections for the medium voltage cables, not illustrated, and are used for connecting and disconnecting cables under de-energized conditions. The deadbreak design prevents exposure to live conductors. Any suitable amperage deadbreak may be used including, but not limited to, 400 A, 500 A, 700 A, and 800 A.

A neutral connection, not illustrated, is also provided within the medium voltage cabinet 142. The neutral connection allows for proper grounding of the transformer secondary side in a wye configuration. This provides a return path for unbalanced currents and facilitating the operation of protective devices.

The medium voltage cabinet 142 may be field installed, allowing for flexibility during installation and transportation. In particular, the medium voltage cabinet 142 can be shipped separately from the transformer 100 and attached on-site using easy mount hangers, not illustrated, for installation. The easy mount hangers reduce installation time and labor costs. Even further, the hangars allow medium voltage cabinet 142 to be securely attached to the housing 106, without the need for specialized tools or equipment. In alternative embodiments, the medium voltage cabinet 142 is installed before being transported.

The medium voltage cabinet 142 of the presented embodiment includes at least one loadbreak surge arrestor, not illustrated, per phase. The loadbreak surge arrestors protect the transformer 100 and connected equipment from transient overvoltages such as lightning strikes and switching surges. The loadbreak feature allows for safe disconnection of the loadbreak surge arrestors under load conditions.

The medium voltage cabinet doors 144 provide access to the interior of the medium voltage cabinet 142. The medium voltage cabinet doors 144 may include gasketed seals to prevent ingress of water, dust, and other contaminants. The medium voltage cabinet doors 144 may also be equipped with handles and locking mechanisms to restrict access to authorized personnel only. For safety, medium voltage cabinet doors 144 may include warning labels indicating the presence of high voltage equipment.

The medium voltage cabinet 142 may also include provisions for cable termination and stress relief. Proper terminations prevent partial discharges and insulation failures. Stress cones or terminations may be used to manage electrical stress at cable ends, not illustrated. The medium voltage section 140 may be designed to accommodate different medium voltage cable types and sizes. The medium voltage cabinet 142 includes an easy mount bottom plate 146. The easy mount bottom plate 146 allows for adjustments to accept various conduit sizes, ensuring compatibility with site-specific requirements. The various conduit sizes include, but not limited to, twelve inches, ten inches, and 8 inches. Cable entry points, not illustrated, are designed to maintain the integrity of the enclosure's environmental protection, using gaskets or sealing compounds to prevent ingress of contaminants.

The transformer 100 includes the plurality of drive legs 124, which are configured to transport the transformer 100 when needed. Each drive leg 124 is connected to transformer 100 via drive leg mounting plates 122. The drive legs 124 enable the transformer 100 to be mobilized during installation or relocation.

Each drive leg 124 includes an attachment arm 148, a support arm 150, and a wheel 152. The attachment arm 148 connects the drive leg 124 to the transformer 100, typically securing it to the sidewalls 108 of the housing 106. The attachment arm 148 further connects to the support arm 150. The connection between the attachment arm 148 and the support arm 150 is relatively perpendicular. The support arms 150 are removably attached to each of the drive leg mounting plates 122.

The support arm 150 attaches to the wheel 152. The wheel 152 enables the transformer 100 to be rolled during transport. A first pair of drive legs 124 is typically disposed on a first side of the transformer 100, with a second pair of drive legs 124 on an opposite side, a second side, allowing for balanced movement. The drive legs 124 are generally disposed closer to the tank base 112 of the transformer 100 than the top plate 110. In some embodiments, the drive legs 124 may be configured to pivot, allowing for greater maneuverability. Additionally, the drive legs 124 may include casters on the wheels 152, facilitating multidirectional movement and easy positioning of the transformer 100.

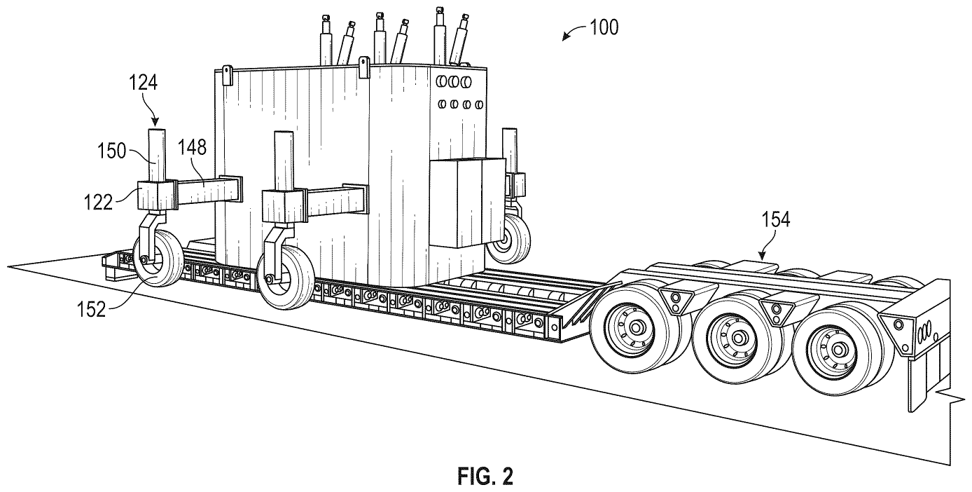

FIG. 2 illustrates the transformer 100 disposed on a transformer trailer 154. The transformer trailer 154 transports the transformer 100 by attaching the transformer trailer 154 to a motor vehicle, not illustrated. One end of the transformer trailer 154 may be attached to the vehicle, while the other end remains free. The transformer trailer 154 may be shaped to fit under the transformer 100, leaving space for the plurality of wheels 152 of the plurality of drive legs 124, which are positioned outside the footprint of the transformer trailer 154.

The transformer trailer 154 may have two distinct heights along its length. A first height, which is measured closer to the motor vehicle, may elevate the transformer 100 from the ground, allowing for easier transport. The second height, which is measured closer to the free end of the trailer 154, may place the transformer 100 closer to the ground for stability during stationary periods. A transitional slope between the first and second heights allows for smooth adjustments of the transformer's 100 elevation.

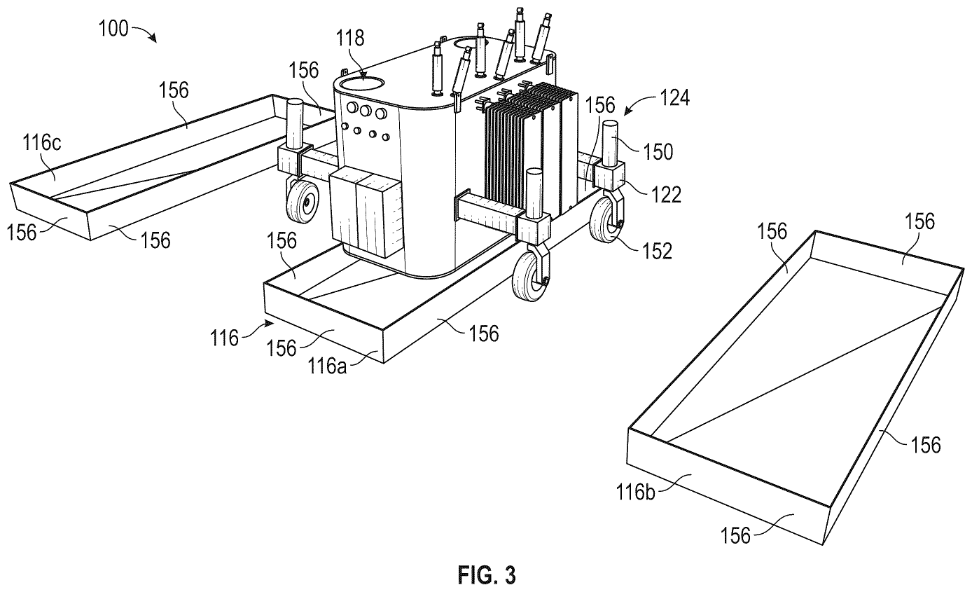

FIG. 3 illustrates the transformer 100 disposed on the containment tray 116. The containment tray 116 can be disposed below the transformer 100. The containment tray 116 fits within the footprint of plurality of drive legs 124 yet outside the footprint of housing 106. In this embodiment, containment tray 116 is rectangular. However, a containment tray 116 can be any suitable shape including, but not limited to, circular and hexagonal. The containment tray 116 may be composed of three pieces including a containment tray first portion 116a, a containment tray second portion 116b, and a containment tray third portion 116c. The containment tray first portion 116a, second portion 116b, and third portion 116c are configured to be attached to each other upon removal of the plurality of drive legs 124. Upon being attached, the containment tray first portion 116a, second portion 116b, and third portion 116c are in fluid communication with each other. The containment tray 116 is configured for above-ground installation. It includes a self-extinguishing grate, not illustrated. The grate has no moving parts. The containment tray 116 includes gravity drain filters therein, not illustrated, that automatically close on leak detection. The containment tray 116 is anchorable in high seismic zones.

The containment tray 116 has a plurality of side walls 156 and functions to collect any leaking insulating fluid or oil from transformer 100. By being disposed below transformer 100, the containment tray 116 prevents environmental contamination in case of leaks. The self-extinguishing grate allows spilled fluids to be contained while reducing fire risks. The self-extinguishing grate of containment tray 116 may be constructed from materials that inhibit combustion. This enhances safety by reducing the chance of fire spreading in the event of an oil leak.

The gravity drain filters close automatically upon leaks. This prevents spilled fluids from escaping the containment area. The containment tray 116 may be made of steel or other durable, corrosion-resistant materials. The containment tray 116 is robust enough to withstand environmental stresses and the weight of the transformer 100. The ability to anchor containment tray 116 in high seismic zones ensures stability during earthquakes. The containment tray 116 may be installed after the transformer 100 is positioned at the site. The three-piece design allows for easy assembly around transformer 100. The containment tray first portion 116a, second portion 116b, and third portion 116c are connected to each other, creating a continuous containment area. The fluid communication between the containment trays 116 is such that any spilled fluids may be evenly distributed within the containment tray portions 116a, 116b, 116c.

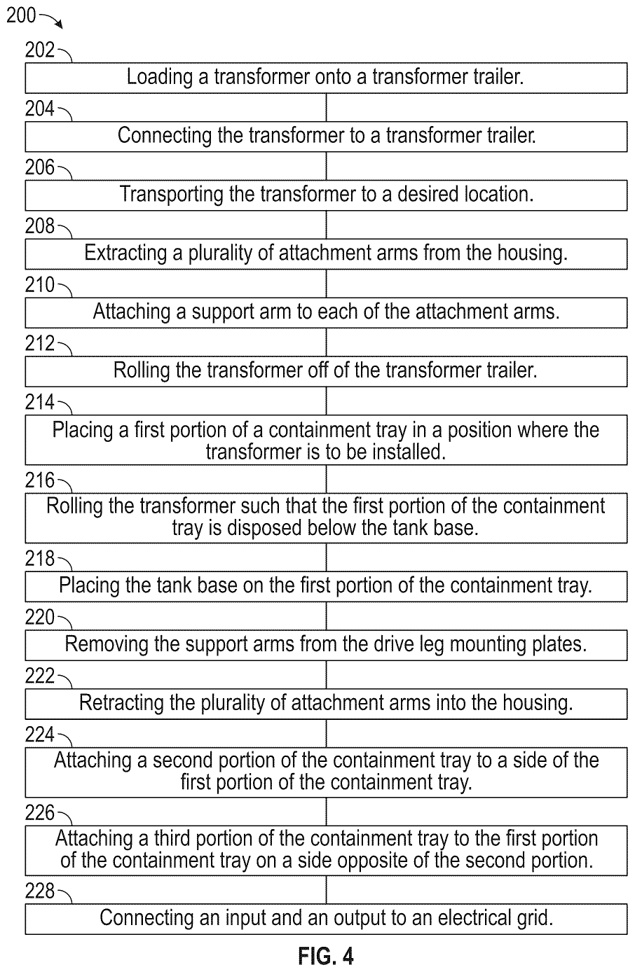

FIG. 4 illustrates an example method 200 of installing a transformer, such as transformer 100. Although the method 200 is being described relative to example transformer 100, the method 200 can be used with respect to any suitable transformer installation. The steps listed below can be done in the order presented. However, the steps can also be done out of the order presented.

A step 202 comprises loading a transformer 100 onto a transformer trailer 154. Another step 204 comprises connecting the transformer trailer 154 to a vehicle. Another step 206 comprises transporting the transformer 100 to a desired location. Another step 208 comprises extracting a plurality of attachment arms 148 from the housing 106 of the transformer 100, each attachment arm 148 having a drive leg mounting plate 122. Another step 210 comprises attaching the support arm 150 to each of the drive leg mounting plates 122 forming a plurality of drive arms 124. Another step 212 comprises rolling the transformer 100 off of the transformer trailer 154. Another step 214 comprises placing a first portion 116a of the containment tray 116 in a position where the transformer 100 is to be installed. Another step 216 comprises rolling the transformer such that the first portion 116a of the containment tray 116 is disposed below the tank base 112. Another step 218 comprises placing the tank base 112 on the first portion 116a of the containment tray 116. Another step 220 comprises removing the support arms 150 from the plurality of drive leg mounting plates 122. Another step 222 comprises retracting the plurality of attachment arms 148 into the housing 106. Another step 224 comprises attaching a second portion 116b of containment tray 116 to a side of the first portion 116a of the containment tray 116. Another step 226 comprises attaching a third portion 116c of the containment tray 116 to the first portion 116a of the containment tray 116 on a side opposite of the second portion 116b of the containment tray 116. Another step 228 comprises connecting an input 102 and an output 102 to the electrical grid.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular arrangements of elements and steps disclosed herein have been selected by the inventor simply to describe and illustrate examples of the invention and are not intended to limit the scope of the invention or its protection, which is to be given the full breadth of the appended claims and any and all equivalents thereof.

What is claimed is:

1. A transformer comprising:
a housing including a plurality of sidewalls, a tank base, and a top plate;
an input and an output attached to the top plate and in electrical communication with a grid;
a plurality of attachment arms extractable from the housing, each of the plurality of attachment arms having a drive leg mounting plate;
a support arm removably attached to each of the drive leg mounting plates, each of the support arms being relatively perpendicular to each of the plurality of attachment arms;
a wheel attached to each of the support arms; and
a containment tray having a plurality of sidewalls disposed below the tank base.

2. The transformer of claim 1, wherein the containment tray includes a first portion, a second portion, and a third portion.

3. The transformer of claim 2, wherein the first portion, the second portion, and the third portion are attached to each other upon removal of the support arms.

4. The transformer of claim 3, wherein upon being attached, the first portion, the second portion, and the third portion are in fluid communication with each other.

5. The transformer of claim 1, wherein the containment tray fits within a footprint of the support arms and outside a footprint of the housing.

6. The transformer of claim 1, wherein the containment tray includes a gravity drain filter within the containment tray.

7. The transformer of claim 6, wherein the gravity drain filter automatically closes upon leak detection.

8. The transformer of claim 1, wherein said transformer includes a plurality inputs and a plurality of outputs; and
wherein each input and output of the plurality of inputs and outputs are in electrical communication with the grid.

9. The transformer of claim 1, further comprising a plurality of bushings; and
wherein the plurality of bushings are mounted on the top plate and around each of the input and the output.

10. The transformer of claim 1, further comprising a plurality of surge arrestors; and
wherein the plurality of surge arrestors are disposed around the input and the output.

11. The transformer of claim 1, wherein said transformer has a power rating ranging between 20 MVA and 50 MVA.

12. The transformer of claim 1, further comprising a control section that is defined by one of the plurality of sidewalls.

13. The transformer of claim 12, wherein the control section includes a plurality of indicator status lights, a plurality of indicator meters, and a control cabinet.

14. The transformer of claim 13, wherein the control cabinet houses control and monitoring equipment.

15. The transformer of claim 13, wherein the control cabinet contains communication interfaces that enable remote monitoring and control of said transformer.

16. The transformer of claim 1, wherein two of the support arms are on a first side and two of the support arms are on a second side that is opposite of the first side.

17. A transformer comprising:
a housing including a plurality of sidewalls, a tank base, and a top plate;
an input and an output attached to the top plate and in electrical communication with a grid;
a plurality of attachment arms extractable from the housing, each of the plurality of attachment arms having a drive leg mounting plate, the plurality of attachment arms includes two attachment arms on a first side and two attachment arms on a second side that is opposite of the first side;
a support arm removably attached to each of the drive leg mounting plates, each of the support arms being relatively perpendicular to each of the plurality of attachment arms;
a wheel attached to each of the support arms; and
a containment tray having a plurality of sidewalls disposed below the tank base, the containment tray including a first portion, a second portion, and a third portion attachable to each other upon removal of the support arms.

18. A method of installing a transformer, the method comprising:
placing a first portion of a containment tray in a position where said transformer is to be installed;
extracting a plurality of attachment arms from a housing, each support arm having a drive leg mounting plate, the housing having a plurality of sidewalls, a tank base, a top plate, an input, and an output;
attaching a support arm having a wheel to each of the drive leg mounting plates;
rolling said transformer such that the first portion of the containment tray is disposed below the tank base;
placing the tank base on the first portion of the containment tray;
removing the support arms from each of the drive leg mounting plates;
retracting the plurality of attachment arms into the housing; and
connecting the input and the output to an electrical grid.

19. The method of installing a transformer of claim 18, the method further comprising:
loading said transformer onto a transformer trailer;
transporting said transformer to a desired location; and
rolling said transformer off of the transformer trailer.

20. The method of installing a transformer of claim 19, the method further comprising:
attaching a second portion of the containment tray to a first side of the first portion of the containment tray; and
attaching a third portion of the containment tray to a second side opposite of the first side of the first portion of the containment tray.
